(19) United States
(12) Patent Application Publication
(10) Pub. No.: US 2026/0311311 A1
(43) Pub. Date: Oct. 8, 2026

(54) ON-DEVICE CNN MODEL FOR PREDICTING SPATIAL COMPLEXITY OF VIDEO FRAMES

(71) Applicant: Samsung Electronics Co., Ltd., Suwon-si (KR)

(72) Inventors: Kevin V. Bui, Huntington Beach, CA (US); Tien C. Bau, Mountain View, CA (US)

(21) Appl. No.: 19/460,073

(22) Filed: Jan. 26, 2026

Related U.S. Application Data
(60) Provisional application No. 63/757,939, filed on Feb. 13, 2025.

(51) Int. Cl. G06T 7/00; G06N 3/0464; G06N 3/0495; G06N 3/082; G06N 3/096

(52) U.S. Cl. CPC G06T 7/0002; G06N 3/0464; G06N 3/0495; G06N 3/082; G06N 3/096; G06T 2207/20081; G06T 2207/20084; G06T 2207/30168

(57) ABSTRACT

A method includes inputting an image into a convolutional neural network (CNN) model. The method also includes estimating, using the CNN model, encoding I-frame bits per pixel for the image. The method also includes measuring, using a defined metric based on the estimated encoding I-frame bits per pixel, a spatial complexity of the image independent from a resolution of the image. The method also includes outputting the spatial complexity of the image.

### CROSS-REFERENCE TO RELATED APPLICATION AND PRIORITY CLAIM

This application claims priority under 35 U.S.C. § 119 (e) to U.S. Provisional Patent Application No. 63/757,939 filed on Feb. 13, 2025, which is hereby incorporated by reference in its entirety.

### TECHNICAL FIELD

This disclosure relates generally to machine learning systems. More specifically, this disclosure relates to an on-device convolutional neural network model for predicting spatial complexity of video frames.

### BACKGROUND

Original video content is computationally expensive to store, process, and broadcast, especially on devices such as on television devices. As a result, video content often is compressed via compression algorithms (e.g., H.264 or H.265) so that the video content can be streamed efficiently on the devices. Unfortunately, compression degrades the original video quality, detrimentally affecting the viewers' experiences. In particular, because image details and textures require more data to store, they are degraded by compression, resulting in lower picture quality for a video frame. For example, scene textures and other textures/details such as hair may appear to be smoothed and blurry as a result of compression.

### SUMMARY

This disclosure relates to an on-device convolutional neural network model for predicting spatial complexity of video frames.

In one embodiment, a method includes inputting an image into a convolutional neural network (CNN) model. The method also includes estimating, using the CNN model, encoding intra-frame (I-frame) bits per pixel for the image. The method also includes measuring, using a defined metric based on the estimated encoding I-frame bits per pixel, a spatial complexity of the image independent from a resolution of the image. The method also includes outputting the spatial complexity of the image.

In another embodiment, an electronic device includes at least one processing device configured to input an image into a convolutional neural network (CNN) model. The at least one processing device is also configured to estimate, using the CNN model, encoding I-frame bits per pixel for the image. The at least one processing device is also configured to measure, using a defined metric based on the estimated encoding I-frame bits per pixel, a spatial complexity of the image independent from a resolution of the image, The at least one processing device is also configured to output the spatial complexity of the image.

In yet another embodiment, a non-transitory machine-readable medium containing instructions that when executed cause at least one processor of an electronic device to input an image into a convolutional neural network (CNN) model, estimate, using the CNN model, encoding I-frame bits per pixel for the image, measure, using a defined metric based on the estimated encoding I-frame bits per pixel, a spatial complexity of the image independent from a resolution of the image, and output the spatial complexity of the image.

Any single one or any combination of the following features may be used with the above embodiments. The defined metric may be a normalization of encoding I-frame bits of the image by the resolution of the image indicating a number of bits on average that is needed to encode a pixel of the image. The defined metric may be estimated using a Y-channel of the image. The CNN model may be trained based on knowledge distilled from a first state of the CNN model. In a second state, the CNN model may be compressed after training based on the knowledge distilled from the first state. To compress the CNN model, torque pruning may be performed using a distance regularization to prune channels of the model having low-value weights. The CNN model may be finetuned after the CNN model is compressed.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example model training and inferencing process in accordance with this disclosure;

FIG. 3 illustrates an example model architecture for a CNN model in accordance with this disclosure;

FIG. 4 illustrates an example knowledge distillation training process in accordance with this disclosure;

FIG. 5 illustrates an example model pruning and finetuning process in accordance with this disclosure;

FIG. 6 illustrates an example patch-based metric estimation process in accordance with this disclosure; and

FIG. 7 illustrates an example method for estimating a spatial complexity metric in accordance with this disclosure.

### DETAILED DESCRIPTION

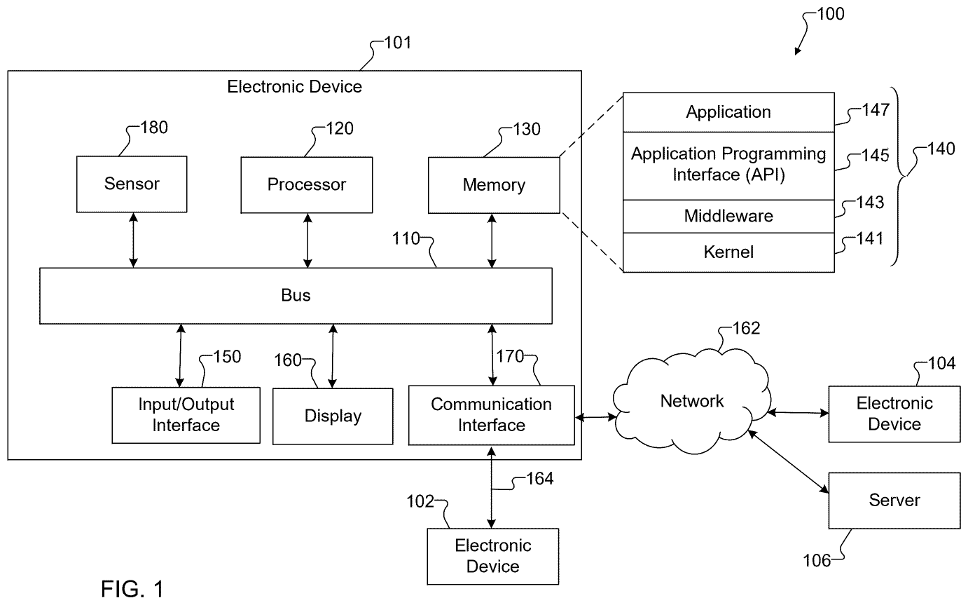

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, original video content is computationally expensive to store, process, and broadcast, especially on devices such as on television devices. As a result, video content often is compressed via compression algorithms (e.g., H.264 or H.265) so that the video content can be streamed efficiently on the devices. Unfortunately, compression degrades the original video quality, detrimentally affecting the viewers' experiences. In particular, because image details and textures require more data to store, they are degraded by compression, resulting in lower picture quality for a video frame. For example, scene textures and other textures/details such as hair may appear to be smoothed and blurry as a result of compression.

This disclosure provides a metric that determines the spatial complexity of a video frame, which encompasses both details and textures. This metric can be used to predict video encoding time and evaluate video frame quality. However, because videos come in different resolutions and can be compressed by different algorithms, the metric of this disclosure is designed to be universal and accurate across different resolutions and compression algorithms. The metric of this disclosure is also convenient to compute in terms of computational time and complexity.

To produce the above-described metric, this disclosure provides a compact convolutional neural network (CNN) model to estimate the proposed metric, resulting in a metric that is universal across different resolutions. In various embodiments of this disclosure, the CNN model is able to fit onto resource-constrained devices, such as neural processing units (NPUs), making it readily accessible for various users.

Thus, a key purpose of this disclosure is to calculate, estimate, or predict a metric (encoding I-frame bits per pixel) that measures the image quality (spatial complexity or the amount of texture/detail) of an input image/video frame. For example, an image is inputted into the CNN of the various embodiments of this disclosure, and the output is the metric (encoding I-frame bits per pixel). This metric (encoding I-frame bits per pixel) is used to measure, evaluate, analyze, or represent the image quality or the spatial complexity (level of image details and textures) of the input image. The image quality analysis provided by the CNN an electronic device in performing artificial intelligence (AI) upscaling (increasing resolution and image quality of an input image).

Note that while some of the embodiments discussed below are described in the context of use in consumer electronic devices (such as smartphones or television devices), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to an on-device convolutional neural network model for predicting spatial complexity of video frames.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to on-device convolutional neural network model for predicting spatial complexity of video frames. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to on-device convolutional neural network model for predicting spatial complexity of video frames.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

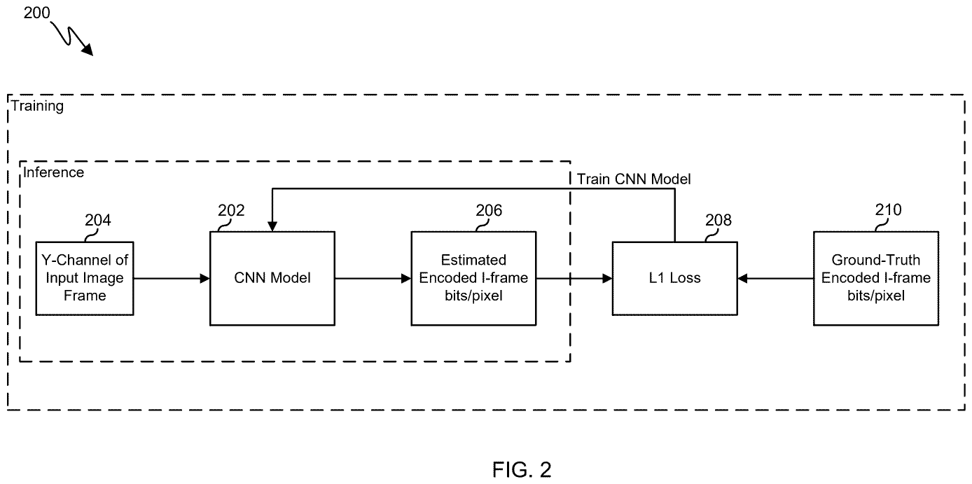

FIG. 2 illustrates an example model training and inferencing process 200 in accordance with this disclosure. For ease of explanation, the process 200 is described as involving the use of the electronic device 101 in the network configuration 100 of FIG. 1. However, the process 200 may be used with any other suitable electronic device(s), such as the server 106, and in any other suitable system(s).

As shown in FIG. 2, a CNN model 202 is provided that is configured to estimate encoded intra-frame (I-frame) bits/pixels. One metric to evaluate the spatial complexity that encompasses details and textures of a video frame is the number of bits required to encode it as an I-frame. Succinctly, this metric will be referred to as I-frame encoding bits. In I-frame encoding, each frame is compressed independently from other frames, so its corresponding encoding data has all the information necessary to reconstruct it.

In using I-frame encoding bits as a metric, various challenges arise that are addressed by the various embodiments of this disclosure. For example, when given a video frame, the I-frame encoding bits are not immediately available to use. Rather, a video analyzing tool such as FAST FORWARD MOVING PICTURE EXPERTS GROUP (FFMPEG) is used to extract such information and integrating FFMPEG onto edge devices may be challenging. Even if a video analyzing tool is able to extract the exact number of encoding bits per frame, not all videos are I-frame encoded. Typically, videos are inter-frame encoded, where most of the video frames are either predicted frames (P-frames) or bidirectional predicted frames (B-frames). Because their encoding is based on reference frames (e.g., previous or subsequent P-frames or I-frames), P-frames and B-frames therefore have significantly less encoding number of bits. Also, the I-frame encoding bits are not normalized across different resolutions. The I-frame encoding bits depend not only the amount of texture and details in an image but also the image resolution. Factoring in image resolution can complicate our understanding of the metric that is meant to evaluate the texture and detail complexity in an image frame. For example, certain image characteristics may confuse the interpretation of the I-frame encoding bits with the amount of texture and details, like images with more details and textures having less I-frame encoding bits than images with smooth features.

To address the aforementioned problems, the CNN model 202 of the various embodiments of this disclosure accurately estimates the spatial complexity of an image frame independent of the image resolution and the video compression algorithm. The CNN model 202 accurately estimates the metric of this disclosure called encoding I-frame bits per pixel, which measures the spatial complexity of an image frame regardless of its resolution. Thus, the CNN model 202 can be used to calculate, estimate, or predict a metric that measures the image quality of an input image. In other words, if an image is input into the CNN model 202, then the CNN model will output a metric that measures the image quality (spatial complexity or level of detail/texture) of the input image.

For example, as shown in FIG. 2, the CNN model 202 takes as an input, in both the training and inference phases, a Y-channel of an input image frame 204. The CNN model 202, using the Y-channel of an input image frame 204, outputs an estimated encoded I-frame bit/pixel 206 (ŷ) In various embodiments, the CNN model 202 can have a relatively low number of parameters, such as about 2000 weight parameters, so that it can fit on a plurality of edge device types, such as an NPU. In some embodiments, as described in this disclosure, even if the model does not fit, the model can be further compressed to a smaller number of parameters, such as about 500 parameters, by a combination of knowledge distillation and channel pruning while still maintaining reasonable accuracy.

The metric of this disclosure, the estimated encoded I-frame bits per pixel 206, can be represented as follows.

$$Encoded I - frame bits per pixel = \frac{Encoded I - frame bits}{Image Height \times Image Width}$$

This metric normalizes the encoding I-frame bits by the image frame resolution, so that it explains how many bits on average are needed to encode a pixel of an image frame. It is correlated with spatial complexity of an image frame, in that the encoding bits per pixel should be low when an image has a low amount of details and textures, and it should be high when an image has a high amount of details and textures. For example, an image with more details/textures may have an encoded I-frame bits per pixel value of 0.57, while an image with less details/textures, such as images with smooth image features, may have a lower value, such as a value of 0.16. These values thus align with the amount of textures and details present in the image frames.

During inferencing, the CNN model thus provides the estimated encoded I-frame bits per pixel 206 as the output. During training, an L1 loss function 208 can be used to train the CNN model, such as shown in FIG. 2, using the estimated encoded I-frame bits per pixel 206 and a ground-truth encoded I-frame bits per pixel 210. The L1 loss can be represented as follows.

$${L}_{1} loss = \frac{1}{N} {\sum }_{i = 1}^{N} \vert {y}_{i} - {\hat{y}}_{i} \vert$$

Here, the L1 loss is characterized by y−ŷ, where y is the ground-truth encoded I-frame bits per pixel 210 and ŷ is the estimated encoded I-frame bits per pixel 206.

The L1 loss is used to compare the predicted value (predicted encoding I-frame bits per pixel) of the CNN model and the ground-truth value, such as calculated by FFMPEG. Hence, during training, L1 loss is being minimized so that CNN more accurately estimates the ground truth encoding I-frame bits per pixel. In other words, minimizing the L1 loss is used to train the CNN model (e.g., during a back propagation stage).

Use of the L1 loss function that uses absolute value ensures the CNN model 202 is robust against outliers. In various embodiments, a dataset can be generated to train the CNN model 202 by gathering a large number (e.g., hundreds) of uncompressed video clips, which can be from a plurality of sets of video clips.

In some embodiments, for the training set, using FFMPEG, each video in I-frame encoding can be compressed using H265 with 5 randomly selected CRF values between 10 and 30. In some embodiments, to reduce redundancy, every 30th frame of each clip can be selected. In some embodiments, the test set generation follows similarly to the training set generation. FFMPEG provides the encoding I-frame bits for each frame, but, in some embodiments, the value can be manually divided by the image frame resolution to obtain the encoding I-frame bits per pixel, the label for the dataset.

Although FIG. 2 illustrates one example of a model training and inferencing process 200, various changes may be made to FIG. 2. For example, various components and functions in FIG. 2 may be combined, further subdivided, replicated, or rearranged according to particular needs. Also, one or more additional components and functions may be included if needed or desired.

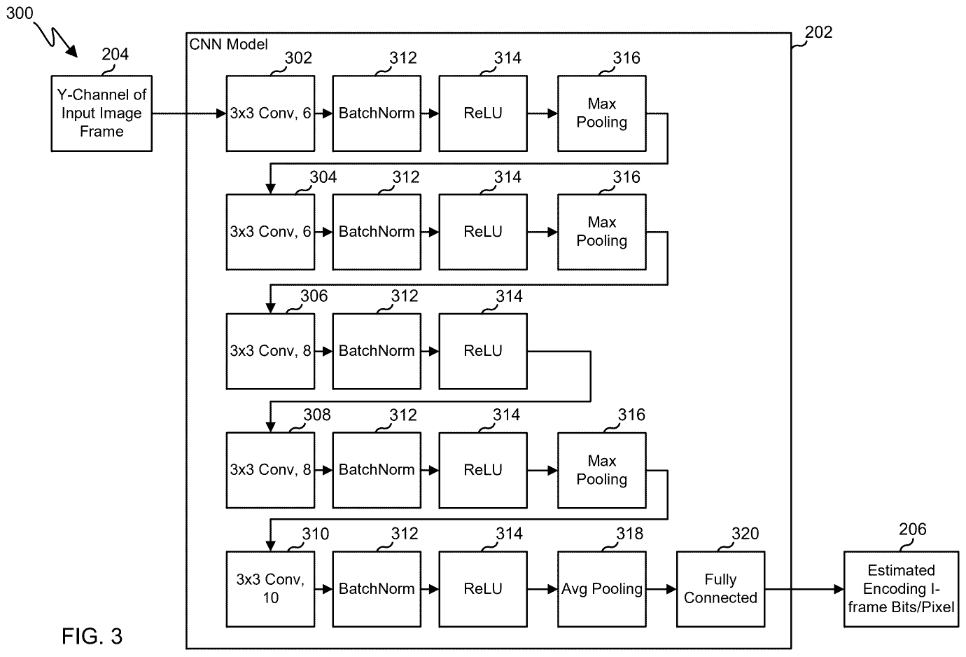

FIG. 3 illustrates an example model architecture 300 for the CNN model 202 in accordance with this disclosure. For ease of explanation, the architecture 300 shown in FIG. 3 is described as being implemented on or supported by the electronic device 101 in the network configuration 100 of FIG. 1. However, the architecture 300 shown in FIG. 3 could be used with any other suitable device(s) and in any other suitable system(s), such as when the architecture 300 is implemented on or supported by the server 106.

As shown in FIG. 3, the architecture 300 of the CNN model 202 can be a compact model including various convolutional layers (e.g., initially six 3×3 convolutional layers 302, followed by another set of six 3×3 convolutional layers 304, followed by a set of eight 3×3 convolutional layers 306, followed by another set of 3×3 convolutional layers 308, followed by a set of 10 3×3 convolutional layers 310), with batch normalization (BatchNorm) layers 312, rectified linear units (ReLU) layers 314, and max pooling layers 316 used between sets of convolutional layers, as shown in FIG. 3. An average pooling layer 318 can follow the last set of convolutional layers, followed by a fully connected layer 320 that outputs the estimated encoded I-frame bits per pixel 206. The CNN model 202 can thus be compact, such as having around 2000 weight parameters, so that it can be stored on various resource-constrained devices. A compact CNN model such as that described in the embodiments of this disclosure can be used because, generally, the first few layers of a CNN model extract the edges, details, and textures of the image, while later layers may lose texture and detail. Therefore, keeping the CNN model compact can assist with avoiding such loss of texture and detail.

Although FIG. 3 illustrates one example of a model architecture 300 for the CNN model 202, various changes may be made to FIG. 3. For example, various components and functions in FIG. 3 may be combined, further subdivided, replicated, or rearranged according to particular needs. Also, one or more additional components and functions may be included if needed or desired.

In various embodiments of this disclosure, the CNN model 202 can be further compressed by adding two stages to the training pipeline: (1) train another model of the same size with channel selection regularization and with knowledge distilled from the first teacher model, and (2) prune the second model's channels to the desired size and fine tune it with knowledge distilled from the first teacher model.

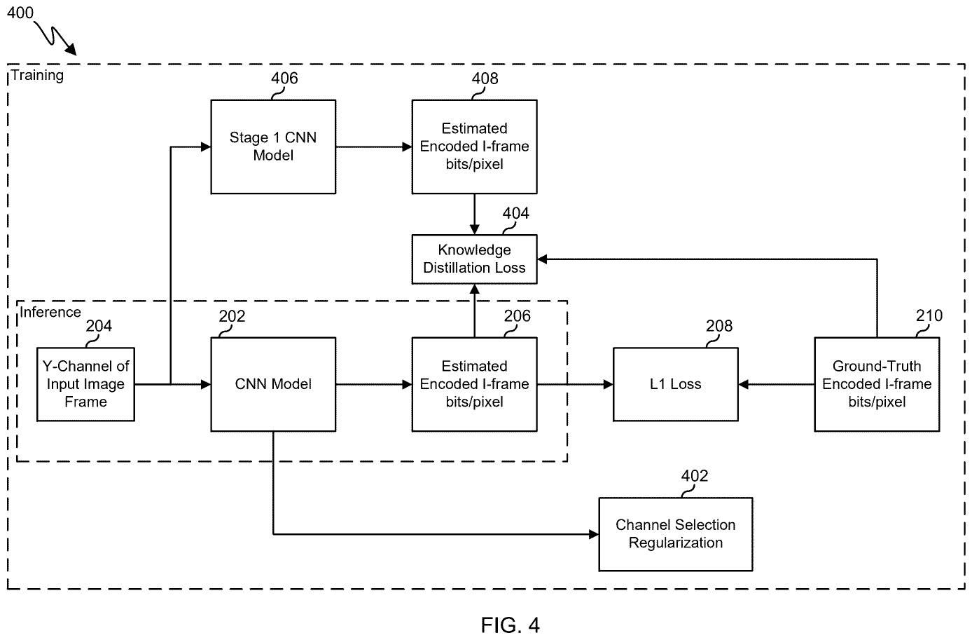

For example, FIG. 4 illustrates an example knowledge distillation training process 400 in accordance with this disclosure. For ease of explanation, the process 400 is described as involving the use of the electronic device 101 in the network configuration 100 of FIG. 1. However, the process 400 may be used with any other suitable electronic device(s), such as the server 106, and in any other suitable system(s).

As shown in FIG. 4, the process 400, like the process 200, includes training the CNN model using the L1 loss function 208. Additionally, the process 400 also includes combining both a channel selection regularization operation 402 and knowledge distillation loss operation 404 to train a stage 1 CNN model 406 (a teach model) of the same size as the CNN model 202. The channel selection regularization operation 402 identifies which channels of the CNN model 202 to prune when the CNN model 202 finishes training. Because channel selection regularization can degrade model accuracy, the knowledge distillation loss operation 404 is used with the stage 1 CNN model 406 as the teacher model to combat against the degradation. As shown in FIG. 4, the stage 1 CNN model 406 receives the Y-channel of the input image frame 204 and outputs its own estimated encoded I-frame bits per pixel 408. The knowledge distillation loss operation 404 uses each of the estimated encoded I-frame bits/pixel 408 from the stage 1 CNN model 406, the estimated encoded I-frame bits/pixel 206 from the CNN model 202, and the ground-truth encoded I-frame bits per pixel 210 to train the CNN model 202 using knowledge distillation.

For the channel selection regularization operation 402, various techniques for channel selection can be used, such as network slimming or torque pruning. For example, torque pruning the CNN model 202 can be represented as follows.

$$torque pruning regularization = {\sum }_{l = 1}^{L} {\sum }_{i = 1}^{{n}_{l}} {d}_{l , i} {‖ {W}_{l , i} ‖}_{1}$$

Here, L is the number of layers in the network, nₗ is the number of channels in layer l=1, . . . , L, d_{l,i} is a distance regularization parameter for channel i in layer l such that d_{l,1}<d_{l,2}< . . . <d_{l,n}_{ₗ}, and W_{l,i} is a weight matrix/tensor of channel i in layer l.

For the knowledge distillation loss operation 404, in various embodiments, a modification to the L2 norm difference can be used between the student output ŷᵢ and the teacher output

$$torque pruning regularization = {\sum }_{l = 1}^{L} {\sum }_{i = 1}^{{n}_{l}} {d}_{l , i} {‖ {W}_{l , i} ‖}_{1}$$

which can be represented as follows.

$$Knowledge Distillation Loss = \frac{1}{N} {\sum }_{i}^{N} exp ( \frac{- {‖ {\hat{y}}_{i}^{T} - {y}_{i} ‖}_{1}}{σ} ) {‖ {\hat{y}}_{i}^{T} - {\hat{y}}_{i} ‖}_{2}^{2}$$

The exponential term in the knowledge distillation loss determines the amount of penalization on the similarity between the student output and the teacher output for each image. If the teacher output is similar to the ground truth label, then the exponential term is closer to 1; otherwise, it is closer to 0.

Although FIG. 4 illustrates one example of a knowledge distillation training process 400, various changes may be made to FIG. 4. For example, various components and functions in FIG. 4 may be combined, further subdivided, replicated, or rearranged according to particular needs. Also, one or more additional components and functions may be included if needed or desired.

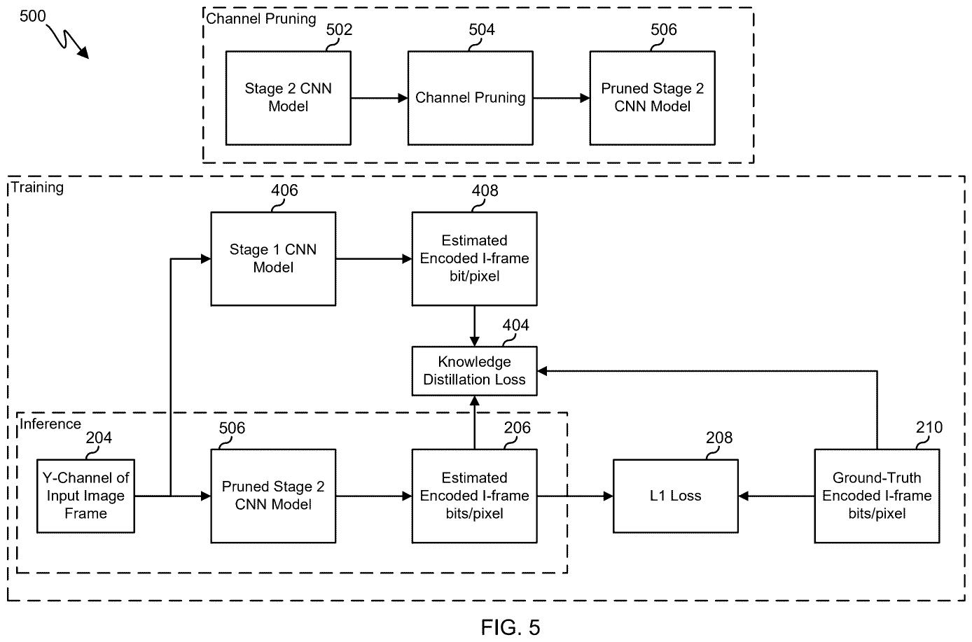

FIG. 5 illustrates an example model pruning and finetuning process 500 in accordance with this disclosure. For ease of explanation, the process 500 is described as involving the use of the electronic device 101 in the network configuration 100 of FIG. 1. However, the process 500 may be used with any other suitable electronic device(s), such as the server 106, and in any other suitable system(s).

After the CNN model from the previous stage shown in FIG. 4 is trained using knowledge distillation, a stage 2 CNN model 502 is provided. This stage 2 CNN model 502 can then be pruned by removing channels identified using the channel selection regularization operation 402 described with respect to FIG. 4. During this channel pruning operation 504, channels of the model are removed, yielding a pruned stage 2 CNN model 506. For example, to prune the CNN model 502, channel i in layer l is removed if ∥W_{l,i}∥₂<ϵ, where ϵ is a selected or predefined threshold. The value of ϵ can be varied to provide different sizes of the pruned CNN model 506; the larger ϵ is, the more compressed the model is.

As also shown in FIG. 5, after pruning the model, the pruned stage 2 CNN model 506 is finetuned because pruning may reduce model accuracy. In various embodiments, the finetuning can involve training the pruned stage 2 CNN model 506 in the similar manner as shown with respect to FIG. 4, involving training using the L1 loss function 208 and the knowledge distillation loss operation 404, but without the channel selection regularization operation 402. As a result of the finetuning, an accurate, compressed model for estimating the encoded I-frame bits per pixel is obtained.

Although FIG. 5 illustrates one example of a model pruning and finetuning process 500, various changes may be made to FIG. 5. For example, various components and functions in FIG. 5 may be combined, further subdivided, replicated, or rearranged according to particular needs. Also, one or more additional components and functions may be included if needed or desired.

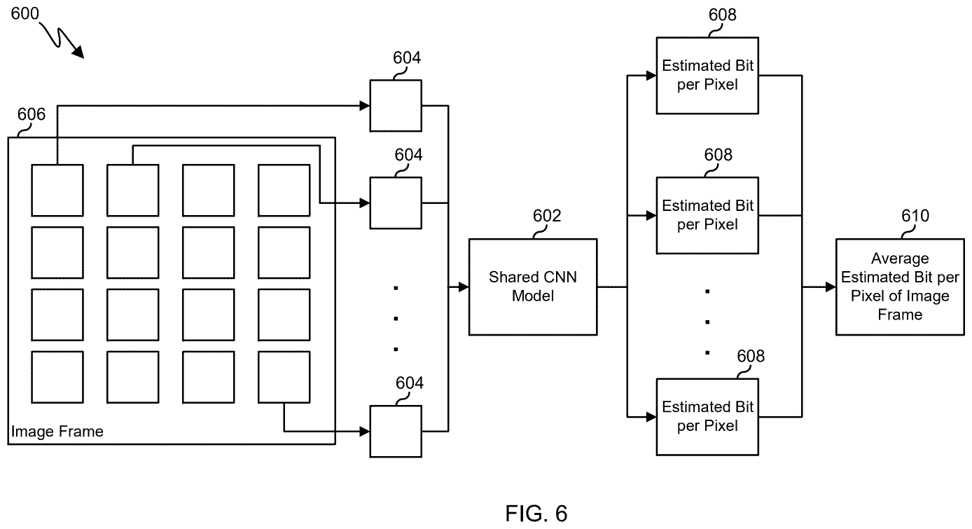

FIG. 6 illustrates an example patch-based metric estimation process 600 in accordance with this disclosure. For ease of explanation, the process 600 is described as involving the use of the electronic device 101 in the network configuration 100 of FIG. 1. However, the process 600 may be used with any other suitable electronic device(s), such as the server 106, and in any other suitable system(s).

Certain edge devices such as NPUs may not allow CNNs to process different resolutions of image frames. To avoid having multiple CNNs, one for each resolution, in various embodiments, a shared CNN model 602 such as that shown in FIG. 6 can be trained to extract a number of patches 604 from an image frame 606, estimate each patch's bits per pixel 608, and compute the average estimated bits per pixel 610 of the image frame.

Although FIG. 6 illustrates one example of a model pruning and finetuning process 600, various changes may be made to FIG. 6. For example, various components and functions in FIG. 6 may be combined, further subdivided, replicated, or rearranged according to particular needs. Also, one or more additional components and functions may be included if needed or desired.

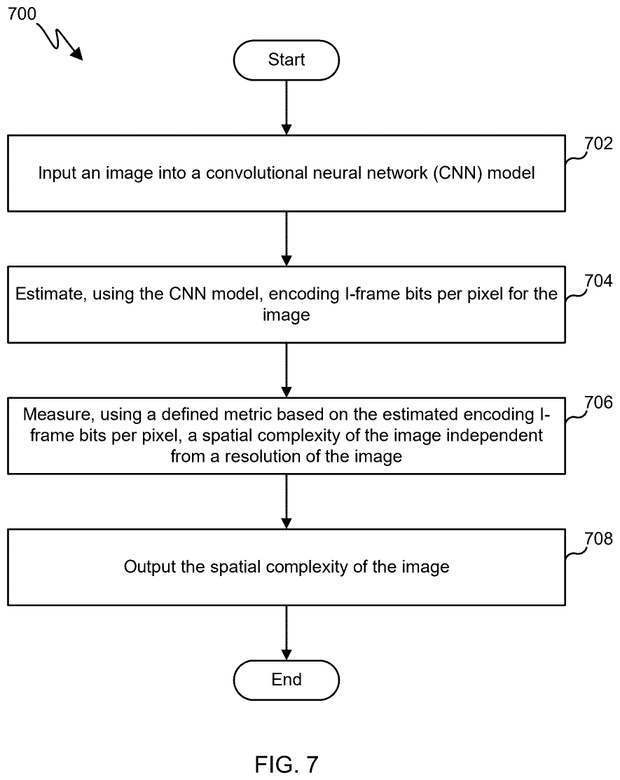

FIG. 7 illustrates an example method 700 for estimating a spatial complexity metric in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, an image is input into a convolutional neural network (CNN) model, such as the CNN model 202 of this disclosure. This can include the processor 120 of the electronic device 101 receiving or retrieving an image capture in a variety of ways and executing the CNN model with the image as an input into the CNN model. At step 704, encoding intra-frame (I-frame) bits per pixel for the image is estimated using the CNN model. In various embodiments as described in this disclosure, the CNN model can be trained based on knowledge distilled from a first state of the CNN model, such as be using a teacher model. As also described in this disclosure, in various embodiments, in a second state, the CNN model can be compressed after training based on the knowledge distilled from the first state. As also described in this disclosure, in various embodiments, to compress the CNN model, torque pruning can be performed using a distance regularization to prune channels of the model having low-value weights. As also described in this disclosure, in various embodiments, the CNN model is finetuned after the CNN model is compressed, such as be performing knowledge distillation using a teacher model.

At step 706, a defined metric based on the estimated encoding I-frame bits per pixel is used to measure a spatial complexity of the image independent from a resolution of the image. In various embodiments, the defined metric is a normalization of encoding I-frame bits of the image by the resolution of the image indicating a number of bits on average that is needed to encode a pixel of the image. In various embodiments of this disclosure, the defined metric is estimated using a Y-channel of the image.

At step 708, the spatial complexity of the image is output. As described in this disclosure, the spatial complexity of the image can be represented by a value where, in various embodiments, higher values indicate higher spatial complexity and lower values indicate less spatial complexity. In various embodiments, where an image has a low spatial complexity, such as a spatial complexity indicated as being below a threshold value, action may be taken to increase image quality, such as by performing AI upscaling on the image. If the image is determined to have higher spatial complexity (e.g., above a threshold value) then AI upscaling may not be used or may be used sparingly.

Although FIG. 7 illustrates one example of a method 700 for estimating a spatial complexity metric, various changes may be made to FIG. 7. For example, while shown as a series of steps, various steps in FIG. 7 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
inputting an image into a convolutional neural network (CNN) model;
estimating, using the CNN model, encoding intra-frame (I-frame) bits per pixel for the image;
measuring, using a defined metric based on the estimated encoding I-frame bits per pixel, a spatial complexity of the image independent from a resolution of the image; and
outputting the spatial complexity of the image.

2. The method of claim 1, wherein the defined metric is a normalization of encoding I-frame bits of the image by the resolution of the image indicating a number of bits on average that is needed to encode a pixel of the image.

3. The method of claim 1, wherein the defined metric is estimated using a Y-channel of the image.

4. The method of claim 1, wherein the CNN model is trained based on knowledge distilled from a first state of the CNN model.

5. The method of claim 1, wherein, in a second state, the CNN model is compressed after training based on the knowledge distilled from the first state.

6. The method of claim 5, wherein, to compress the CNN model, torque pruning is performed using a distance regularization to prune channels of the model having low-value weights.

7. The method of claim 5, wherein the CNN model is finetuned after the CNN model is compressed.

8. An electronic device comprising:
at least one processing device configured to:
input an image into a convolutional neural network (CNN) model;
estimate, using the CNN model, encoding intra-frame (I-frame) bits per pixel for the image;
measure, using a defined metric based on the estimated encoding I-frame bits per pixel, a spatial complexity of the image independent from a resolution of the image; and
output the spatial complexity of the image.

9. The electronic device of claim 8, wherein the defined metric is a normalization of encoding I-frame bits of the image by the resolution of the image indicating a number of bits on average that is needed to encode a pixel of the image.

10. The electronic device of claim 8, wherein the defined metric is estimated using a Y-channel of the image.

11. The electronic device of claim 8, wherein the CNN model is trained based on knowledge distilled from a first state of the CNN model.

12. The electronic device of claim 11, wherein, in a second state, the CNN model is compressed after training based on the knowledge distilled from the first state.

13. The electronic device of claim 12, wherein, to compress the CNN model, torque pruning is performed using a distance regularization to prune channels of the model having low-value weights.

14. The electronic device of claim 12, wherein the CNN model is finetuned after the CNN model is compressed.

15. A non-transitory machine-readable medium containing instructions that when executed cause at least one processor of an electronic device to:
input an image into a convolutional neural network (CNN) model;
estimate, using the CNN model, encoding intra-frame (I-frame) bits per pixel for the image;
measure, using a defined metric based on the estimated encoding I-frame bits per pixel, a spatial complexity of the image independent from a resolution of the image; and
output the spatial complexity of the image.

16. The non-transitory machine-readable medium of claim 15, wherein the defined metric is a normalization of encoding I-frame bits of the image by the resolution of the image indicating a number of bits on average that is needed to encode a pixel of the image.

17. The non-transitory machine-readable medium of claim 15, wherein the CNN model is trained based on knowledge distilled from a first state of the CNN model.

18. The non-transitory machine-readable medium of claim 17, wherein, in a second state, the CNN model is compressed after training based on the knowledge distilled from the first state.

19. The non-transitory machine-readable medium of claim 18, wherein, to compress the CNN model, torque pruning is performed using a distance regularization to prune channels of the model having low-value weights.

20. The non-transitory machine-readable medium of claim 19, wherein the CNN model is finetuned after the CNN model is compressed.
